(19) United States
(12) Patent Application Publication
(10) Pub. No.: US 2016/0027348 A1
(43) Pub. Date: Jan. 28, 2016

(54) ELECTRONIC LABELLING SYSTEM

(71) Applicant: STORE ELECTRONIC SYSTEMS, Argenteuil (FR)

(72) Inventor: Bernard JOLIEY, Saint-Raphael (FR)

(73) Assignee: STORE ELECTRONIC SYSTEMS, Argenteuil (FR)

(21) Appl. No.: 14/774,864

(22) PCT Filed: Feb. 27, 2014
(86) PCT No.: PCT/FR2014/050421

§ 371 Date: Sep. 11, 2015

(30) Foreign Application Priority Data
Mar. 11, 2013 (FR) 13 52134

(51) Int. Cl. G09F 3/20

(52) U.S. Cl. CPC G09F 3/208; G09F 3/204

(57) ABSTRACT

Electronic labelling system with rail 1 supporting labels fixed onto the edge face of a shelf, the rail and the shelf having the same height, the rail 1 having a free edge 8 and a top groove 9. The electronic label 2 bears a ridge 15 that can be inserted into the groove 9 of the rail 1, and a member 16 for fixing to the free edge 8 of the rail 1.

The invention relates to an electronic labelling system, and more particularly, an electronic labelling system comprising: a rail supporting electronic labels fixed to a shelf, the rail and the shelf having substantially the same height, the rail comprising a rear part for fixing to the shelf and a front part having a free bottom edge and a longitudinal groove in its top part; and at least one electronic label comprising a locking member cooperating with locking means of the rail to ensure that the label is locked in translation on the rail, the height of the electronic label being greater than the height of the rail.

Such an electronic system is described in the document FR 2 919 419 which provides, between the rail and the electronic label, a label-holder suitable for being clipped onto the rail.

The label-holder has a bracket-shaped profile with a flat bottom and a bottom wing bearing an upwardly protruding longitudinal ridge.

The flat bottom bears, in its top part, a longitudinal ridge intended to cooperate with a corresponding groove of the rail. In its median zone, the flat bottom comprises a fixing member with bent profile, which defines an upwardly open groove.

The label-holder is located by insertion of the free edge of the rail into the groove of the label-holder, the ridge of the top part of the label-holder bearing on the rail. During the upward movement of the label-holder, the ridge reaches the groove of the rail and is inserted therein. The label-holder is then in place on the rail and can be moved longitudinally on the rail. It can also be removed from the rail without any particular tools.

The electronic label is then located. Its bottom longitudinal groove is placed on the ridge of the bottom wing of the label-holder.

The top part of the label is pushed back towards the bottom of the label-holder, the ridge serving as pivoting axis, and the locking member being pushed back into the label by the chamfered profile of the top wing of the front part of the rail.

The assembly of the label and of the label-holder is then moved longitudinally on the rail to an orifice constituting the locking means of the rail, in which the locking member of the label is engaged.

For the label and the label-holder to remain secured together, the bottom face of the label has a central zone of a width substantially equal to the ridge of the bottom wing of the label-holder, and two end zones of lesser width, to ensure the holding of the label-holder.

Moreover, the top wing of the front part of the rail has, behind its chamfered profile, a thinned strip in which emerges the groove intended to receive the longitudinal ridge of the top part of the label-holder.

This electronic labelling system presents, for each of the three constituent parts, a production difficulty. The rail has to include, in its top wing, a thinned strip. The label-holder has to include, on its bottom wing, a ridge. The label has to include, on its bottom face, a central zone suitable for receiving the ridge of the label-holder and two end zones suitable for ensuring the holding thereof. The complexity in producing the electronic labelling assembly results in a high manufacturing cost and difficult implementation.

A first aim of the invention is to propose an electronic labelling system that is less complex to produce.

Another aim of the invention is to propose an electronic labelling system that is simple to implement.

The subject of the invention is an electronic labelling system, comprising:
a rail supporting electronic labels fixed to a shelf, the rail and the shelf having substantially the same height, the rail comprising a rear part for fixing to the shelf and a front part comprising a flat bottom and a top wing, the flat bottom having a free bottom edge and a longitudinal groove in its top part, and
at least one electronic label comprising a locking member cooperating with locking means of the rail to ensure that the label is locked in translation on the rail, the height of the electronic label being greater than the height of the rail, characterized in that:
the electronic label bears, on its rear face, a ridge suitable for being inserted into the longitudinal groove of the flat bottom of the rail, and a member for fixing to the free edge of the flat bottom of the rail.

Advantageously, the ridge suitable for being inserted into the longitudinal groove of the flat bottom of the rail is a longitudinal ridge.

Advantageously, the member for fixing to the free edge of the flat bottom of the rail is a member, with bent profile, defining, with the rear face of the label, an upwardly open groove suitable for receiving the free edge of the rail.

Advantageously, the member for fixing to the free edge of the rail is a longitudinal member.

Another subject of the invention is a method for locating an electronic label in an electronic labelling system as described above, characterized by the steps of:

a—placing the label bearing on the rail, on the one hand by the top ridge of the label on the flat bottom of the rail, on the other hand by the rear face of the label on the free edge of the rail;

b—raising the label until the free edge of the rail is in the groove of the fixing member, and the top ridge of the label is engaged in the longitudinal groove of the rail, the locking member of the label then being inserted into the longitudinal groove of the top wing of the rail;

c—sliding the label along the rail to bring the locking member opposite a locking orifice of the rail.

Other features, details and advantages of the invention will emerge from the following description of an exemplary embodiment, given by way of illustration and in a nonlimiting manner, with reference to the drawings in which:

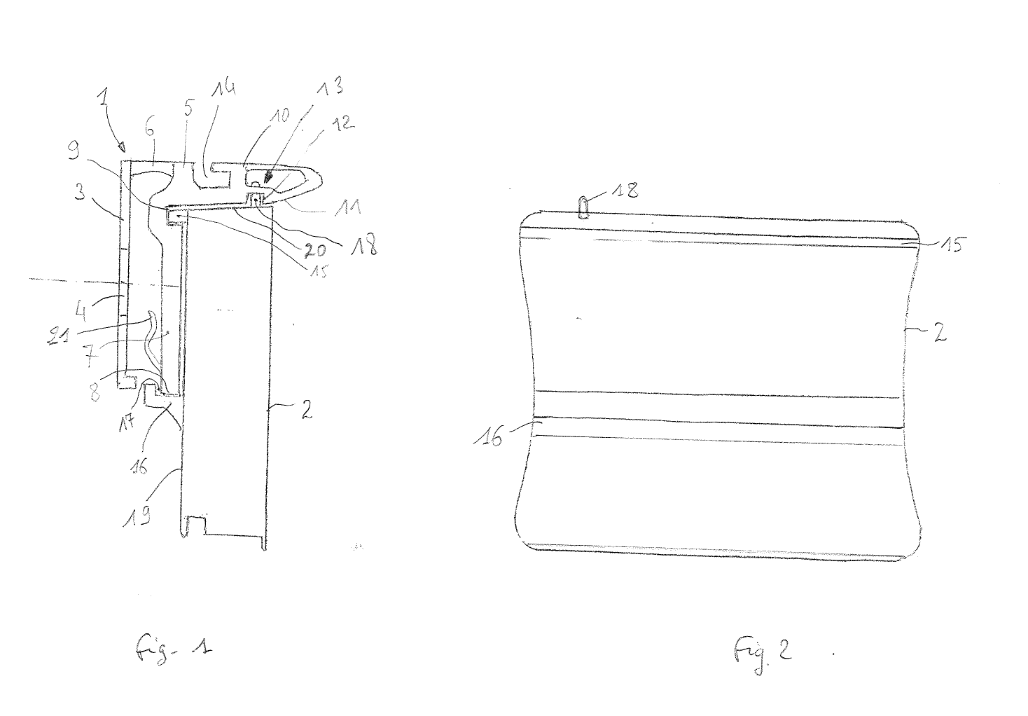

FIG. 1 is a cross-sectional view of an electronic labelling system according to the invention;

FIG. 2 is a view of the back of the electronic label of FIG. 1.

The electronic labelling system according to the invention consists of a rail 1 and an electronic label 2. The rail 1 consists of a rear part 3, and a front part 5 joined by a flexible articulation hinge 6. The rear part 3 essentially consists of a plate, having orifices 4, preferably rectangular, the length of which is parallel to the longitudinal axis of the rear part 3. The rear part 3 of the rail 1 is applied to the edge face of a shelf, to which it is fixed in a known manner, for example by means of a cam introduced into the orifice 4 and immobilized by rotation in the C-shaped profile edge of the shelf

The front part 5 of the rail 1 essentially comprises a flat bottom 7 and a top wing 10. The flat bottom 7 has a free longitudinal edge 8 in its bottom part, and a longitudinal groove 9 in its top part. The flat bottom 7 has substantially the same height as the rear part 3 of the rail and this height corresponds to the thickness of the shelf The top wing 10 of the rail 1 extends forwards from the flat bottom 7, above the longitudinal groove 9. In its bottom part, the wing 10 has a longitudinal groove 12, the bottom of which is pierced, at regular intervals, with orifices 13. Towards the front, beyond the groove 12, the wing 10 has a chamfered profile 11. In its top part, the wing 10 has, advantageously, a longitudinal cavity 14 suitable for ensuring the attachment of a protective cover for the labels.

On its rear face, facing the rear part 3 of the rail, the bottom 7 of the rail preferably has a gutter 21, into which can be inserted a wing of an angle iron, the other wing of which is intended to bear on the rear part 3. When the angle iron is in place, the front part 5 of the rail is inclined relative to the rear part 3, which allows for a better visibility of the label on a low shelf for example.

The wing of the angle iron bearing on the rear part of the rail is of a length suited to the inclination desired for the label. By way of example, the angles proposed between the two parts of the rail are 30°, 45° and 60° depending on the altitude of the shelves relative to the ground, in order to offer the best possible legibility of the labels.

The electronic label 2 has the general form of a rectangular parallelepiped. Its front and rear faces are substantially flat, its vertical lateral faces being able to be curved. The height of the label 2 is substantially greater than that of the rail 1 and of the shelf.

The rear face 19 of the label has, in its top part, a longitudinal ridge 15 suitable for being inserted into the longitudinal groove 9 of the flat bottom 7 of the rail 1. The rear face 19 also bears a longitudinal member 16 for fixing to the free edge 8 of the flat bottom 7 of the rail 1. This member 16 has a bent profile and it defines, with the rear face 19, an upwardly open groove 17 suitable for receiving the free edge 8 of the bottom 7 of the rail 1. Advantageously, the top face 20 of the label 2, which extends from the top ridge 15 to the front face of the label, is slightly inclined, like the bottom face of the top wing 10 of the rail 1, to facilitate the locating of the label on the rail. This top face 20 comprises an orifice to allow a locking member 18 to pass through, such as a pin stressed upwards by a spring, intended to penetrate into an orifice 13 of the top wing 10 of the rail 1 to ensure that the label 2 is locked in position relative to the rail 1.

With the rail 1 fixed to the shelf, the locating of the label 2 proceeds as follows. The label 2 is placed bearing on the rail 1, on the one hand at the level of the top ridge 15 of the label on the bottom 7 of the rail 1, on the other hand at the level of the rear face 19 of the label on the free edge 8 of the rail 1.

The label 2 is then raised while keeping its two bearings on the rail 1. During this upward movement, the locking member 18 comes to bear on the chamfered profile 11 of the top wing 10 of the rail 1, and it is gradually pushed back by compressing its spring. At the end of movement, the free edge 8 of the bottom 7 of the rail 1 is inserted into the groove 17 of the label 2; the top ridge 15 of the label is inserted into the longitudinal groove 9 of the bottom 7 of the rail 1; and the locking member 18 reaches the longitudinal groove 12 of the top wing 10 of the rail 1, into which it protrudes under the action of its spring. The rear face 19 of the label 2 is substantially parallel to the bottom 7 of the rail 1.

The label 2 is then held in position on the rail 1. In effect, the ridge 15 in the groove 9 prevents the label 2 from dropping, and the locking member 18 in the groove 12 prevents the label from pivoting forwards.

At this stage, the label 2 is moved along the rail 1 to bring the locking member 18 opposite a locking orifice 13 arranged at the bottom of the groove 12. The orifices 13 are arranged regularly along the bottom of the groove 12, with a pitch of approximately 10 mm, by way of example. The locking member 18, stressed by its spring, penetrates into the orifice 13 and the label 2 is then locked in position relative to the rail 1.

To release the label, it is necessary to have an appropriate tool, with magnet for example, to ensure the depression of the locking member 18 into the label 2, which makes it possible to pivot the label forwards, for the ridge 15 to exit from the groove 9, and for it to be disengaged downwards.

In the exemplary embodiment described, the rear face 19 of the label 2 bears a member 16 for fixing to the free edge 8 of the flat bottom 7 of the rail 1, which extends over all the length of the label 2. The invention also covers the case where the member 16 for fixing to the free edge 8 is shorter than the label 2. By way of example, the fixing member 16 can consist of at least one hook for fixing to the free edge 8 of the bottom 7 of the rail 1.

Similarly, the longitudinal ridge 15 borne by the rear face 19 of the label can be shorter than the label and be reduced to consist of at least one pin.

1. Electronic labelling system, comprising:
a rail (1) supporting electronic labels fixed to a shelf, the rail and the shelf having substantially the same height, the rail (1) comprising a rear part (3) for fixing to the shelf and a front part (5) comprising a flat bottom (7) and a top wing (10), the flat bottom (7) having a free bottom edge (8) and a longitudinal groove (9) in its top part, and
at least one electronic label (2) comprising a locking member (18) cooperating with locking means (13) of the rail (1) to ensure that the label (2) is locked in translation on the rail (1), the height of the electronic label (2) being greater than the height of the rail, characterized in that:
the electronic label (2) bears, on its rear face (19), a ridge (15) suitable for being inserted into the longitudinal groove (9) of the flat bottom (7) of the rail (1), and a member (16) for fixing to the free edge (8) of the flat bottom (7) of the rail (1).

2. Electronic labelling system according to claim 1, characterized in that the ridge (15) suitable for being inserted into the longitudinal groove (9) of the flat bottom (7) of the rail (1) is a longitudinal ridge.

3. Electronic labelling system according to claim 1, characterized in that the member (16) for fixing to the free edge (8) of the flat bottom (7) of the rail (1) is a member with bent profile, defining, with the rear face (19) of the label (2), an upwardly open groove (17) suitable for receiving the free edge (8) of the rail (1).

4. Electronic labelling system according to claim 3, characterized in that the member (16) for fixing to the free edge (8) of the rail (1) is a longitudinal member.

5. Method for locating an electronic label in an electronic labelling system according to claim 1, characterized by the steps of:
a—placing the label (2) bearing on the rail (1), on the one hand by the top ridge (15) of the label (2) on the flat bottom (7) of the rail (1), on the other hand by the rear face (19) of the label on the free edge (8) of the rail (1);
b—raising the label (2) until the free edge (8) of the rail (1) is in the groove (17) of the fixing member (16) and the top ridge (15) of the label (2) is engaged in the longitudinal groove (9) of the rail (1), the locking member (18) of the label (2) then being inserted into the longitudinal groove (12) of the top wing (10) of the rail (1);
c—sliding the label (2) along the rail (1) to bring the locking member (18) opposite a locking orifice (13) of the rail.
